(19) United States
(12) Patent Application Publication
(10) Pub. No.: US 2017/0044001 A1
(43) Pub. Date: Feb. 16, 2017

(54) A STIRRUP

(71) Applicant: INTELLIGENT INVENTIONS LIMITED, Surfers Paradise, Queenland (AU)

(72) Inventor: ADRIAN MORGANTE, QUEENSLAND (AU)

(21) Appl. No.: 15/306,229

(22) PCT Filed: Apr. 24, 2015
(86) PCT No.: PCT/AU2015/050197

§ 371 Date: Oct. 24, 2016

(30) Foreign Application Priority Data
Apr. 24, 2014 (AU) 2014901488

(51) Int. Cl. B68C 3/00

(52) U.S. Cl. CPC B68C 3/00; B68C 2003/0083; B68C 2003/005; B68C 2003/0075

(57) ABSTRACT

A horse stirrup is provided including a support, for supporting an underside of footwear of a rider; and a positioner, for positioning the footwear of the rider relative to the support. Advantageously, the positioner assists the rider to ride with the ball of their foot (or toes) correctly positioned on the stirrup and in a balanced riding position.

### RELATED APPLICATION(S)

This application is a national phase application of International Application No. PCT/AU2015/050197 filed Apr. 24, 2015, which claims the benefit of and priority to Australian Application Ser. No. AU2014901488 filed on Apr. 24, 2014. The entireties of such applications are published in the English language and incorporated by reference.

### TECHNICAL FIELD

The present invention relates to horse stirrups. In particular, although not exclusively, the present invention relates to ergonomic and safe stirrups for horse riding.

### BACKGROUND ART

Stirrups are generally used to support a foot of a rider while riding a horse (or other animal). Stirrups are generally attached to the saddle by a strap, and can increase a rider's ability to control his or her movement and thus provide stability on a horse.

Stirrups can be set to different lengths, depending on a riding style and level of experience of the rider. A shorter stirrup generally allows more mobility, whereas a longer stirrup allows greater control.

In the horse racing industry, riders have changed their stirrup length from long to very short. A short stirrup enables riders to gain better leverage when riding horses that pull. Furthermore, a short stirrup also helps riders sit up over the horse's shoulders therefore keeping weight off the horses back.

There are, however, safety concerns associated with the use of stirrups of the prior art, including a risk that a fallen rider may get their foot caught in the stirrup and be dragged by the horse. In particular, a rider's foot can slip forward and through the stirrup, or become wedged in the stirrup, and thus become entangled or wedged in the stirrup after a fall. Further movement of the horse then causes the rider to be dragged behind the horse.

Jockeys worldwide are now riding on the ball of their foot to improve their riding position. However, with stirrups of the prior art, this results in the rider's feet being awkwardly placed on the base of the stirrup, generally with their toes hard pressed against the outer bar of the stirrup iron in an endeavour to prevent their feet slipping.

Riding with toes hard pressed against the outer bar of the stirrup iron is not an optimal riding position and it is very difficult for a rider to maintain such an awkward foot position. There is regular video and photo evidence of jockey's feet slipping forward or slipping off the stirrup when jumping from barrier stalls or when riding a horse out during the race. This also applies in the equestrian and leisure riding industry due to unpredictable sudden movements and nature of horses. Accordingly, riding in such a manner puts the rider at a high-risk of falling off or being hooked up in the stirrup and dragged behind the horse.

Accordingly, there is a need for an improved stirrup.

It will be clearly understood that, if a prior art publication is referred to herein, this reference does not constitute an admission that the publication forms part of the common general knowledge in the art in Australia or in any other country.

### SUMMARY OF INVENTION

The present invention is directed to horse stirrups, which may at least partially overcome at least one of the abovementioned disadvantages or provide the consumer with a useful or commercial choice.

With the foregoing in view, the present invention in one form, resides broadly in a horse stirrup including:

a support, for supporting an underside of footwear of a rider; and

a positioner, for positioning the footwear of the rider relative to the support.

The positioner assists the rider to ride with the ball of their foot (or toes) correctly positioned on the stirrup and in a balanced riding position. In the racing industry, for example, this allows the horse to use the full power of their hindquarters to propel the horse and rider upward and forward.

Preferably, the support is a tread.

According to certain embodiments, the positioner is adapted to position the foot of the rider obliquely relative to the tread. This can cause a rider's foot to ‘wedge’ into the stirrup at a safe angle, and thus help prevent the rider's foot from accidently coming out of the stirrup or slipping forward or sideways on the stirrup. The positioner can be asymmetric along a lateral axis of the stirrup.

According to certain embodiments, the positioner comprises a cage, adapted to receive a front portion of the rider's foot, e.g. the toes or the ball of the rider's foot. The cage can extend asymmetrically from one side of the stirrup to another side of the stirrup. The cage can also help prevent a rider from being caught in the stirrup with the possibility of being dragged by the horse if thrown.

According to certain embodiments, the stirrup comprises a structural frame supporting the tread. The structural frame can be a structural ring. The structural ring can be non-circular.

The structural frame may include an opening, which allows the foot to come out of the frame in the event of a fall. The structural frame may define an outer bar which extends outwardly and upwardly from the support, and wherein the opening is defined above the outer bar.

The support may be defined in part by the structural frame.

Preferably, the tread extends outwardly from a lower portion of the structural frame/ring, in a direction that is substantially orthogonal to the structural frame/ring. In such case, the extended tread can provide a larger foot surface area which can in turn increase stability and balance of the rider. The tread may be angled downwards towards a front of the stirrup.

According to certain embodiments, the positioner comprises one or more support bars. The support bars can extend outwardly from a lower portion of the structural frame/ring, then upwards. The support bars may then extend inward again, to join with an upper portion of the structural frame/ring.

The stirrup can further include a brace, extending substantially horizontally across the support bars from one side of the structural ring to the other. The brace can prevent the support bars from deforming under pressure and can provide a smooth surface that prevents any shoulder rubbing to the horse when ridden with a short stirrup length.

According to certain embodiments, the structural ring has a generally arched shaped upper portion. The upper portion can include an aperture for hanging the stirrup. The aperture can be centrally placed in the structural ring.

According to certain embodiments, the tread includes a plurality of raised protuberances defining a gripping surface on the tread. The gripping surface can help prevent the foot of the rider sliding laterally with respect to the tread.

The stirrup can be integrally formed. According to some embodiments, the stirrup is integrally formed of plastic polymer, stainless steel, or aluminium.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a rear upper perspective view of a stirrup, according to an embodiment of the present invention;

FIG. 2 illustrates a front upper perspective view of the stirrup of FIG. 1;

FIG. 3 illustrates a front view of the stirrup of FIG. 1;

FIG. 4 illustrates a rear view of the stirrup of FIG. 1;

FIG. 5 illustrates a lower rear perspective view of the stirrup of FIG. 1;

FIG. 6 illustrates a front perspective view of the stirrup of FIG. 1 with reference to a riding boot, according to an embodiment of the present invention;

FIG. 7 illustrates a front perspective view of a stirrup, according to an alternative embodiment of the present invention;

FIG. 8 illustrates a front view of the stirrup of FIG. 7;

FIG. 9 illustrates atop view of the stirrup of FIG. 7;

FIG. 10 illustrates a rear perspective view of a stirrup, according to an yet an alternative embodiment of the present invention;

FIG. 11 illustrates a front perspective view of the stirrup of FIG. 10 with reference to the riding boot, according to an embodiment of the present invention;

FIG. 12 illustrates a rear perspective view of a stirrup, according to an alternative embodiment of the present invention;

FIG. 13 illustrates a front perspective view of the stirrup of FIG. 12 with reference to the riding boot, according to an embodiment of the present invention;

FIG. 14 illustrates a rear upper perspective view of a stirrup, according to an alternative embodiment of the present invention; and

FIG. 15 illustrates a rear upper perspective view of a stirrup, according to yet an alternative embodiment of the present invention;

FIG. 16 illustrates a front upper perspective view of a stirrup, according to yet an alternative embodiment of the present invention; and

FIG. 17 illustrates a side view of the stirrup of FIG. 16.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

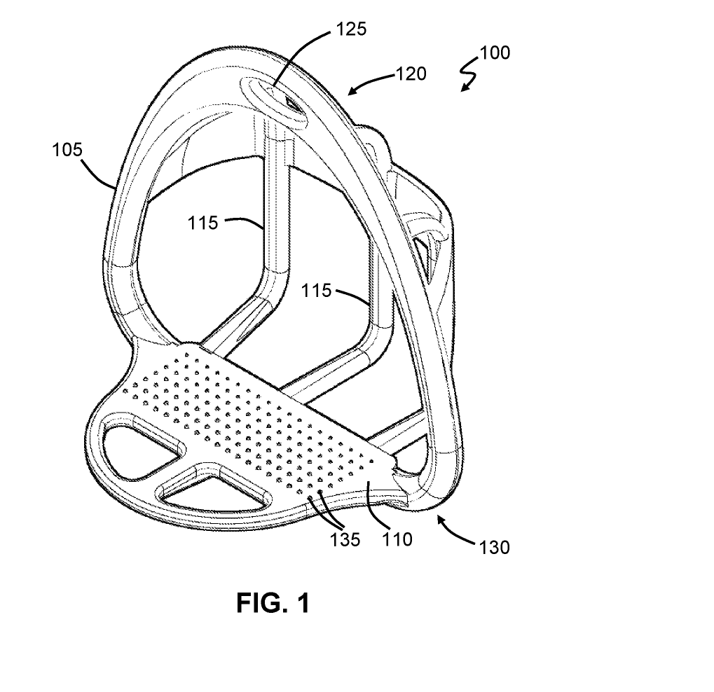

FIG. 1 illustrates a rear upper perspective view of a stirrup 100, according to an embodiment of the present invention. The stirrup 100 is adapted to be used in horse racing, as a short stirrup, but the skilled addressee will appreciate that other uses and variations are also possible, without departing from the scope of the present invention.

The stirrup 100 includes a structural ring 105, a tread 110, for supporting an underside of a foot of the rider, and a plurality of support bars 115 defining a positioner, for positioning the foot of the rider relative to the tread 110. The structural ring 105 has a generally arched shape upper portion 120 including an aperture 125 that is centrally placed in the structural ring 105, for hanging the stirrup 100. In use, the stirrup is hung from, for example, a saddle by a strap that extends through the aperture 125.

The tread 110 extends outwardly from a lower portion 130 of the structural ring 105, in a direction that is substantially orthogonal to the structural ring 105, and provides ‘vertical’ support to a foot of a rider. The tread 110 includes a plurality of raised protuberances 135 defining a gripping surface on the tread 110, which can help prevent the foot of the rider sliding with respect to the tread 110.

The support bars 115 provide support to a front portion the foot of the rider by preventing the foot from moving past a certain point inward through the structural ring 105. In particular, the stirrup 100 is adapted to allow only the ball of the rider's foot (or toes) to extend through the structural ring 105. The support bars 115 extend from the lower portion 130 of the structural ring 105, outwardly in a direction opposite to the tread 110 extends, then upward and later inward again, to join with the upper portion 120 of the structural ring 105. The support bars 115 extend outwards from the structural ring 105 enough to enable the toes of the rider to extend though the structural ring 105 to an extent that provides a balanced foot posture, while at the same time preventing the foot of the rider from extending through the structural ring 105 and thus being caught in the stirrup 100.

In particular, in the case of horse racing, stirrup 100, and in particular the support bars 115, can prevent a jockey's feet from slipping forward or sideways, which slipping can be a major problem causing the rider to become unbalanced or fall off the horse.

In the case of show jumping, the stirrup 100 can improve a rider's balance and performance by preventing the rider's feet from shifting forward. The inventor has observed that even some of the best show jumping riders in the world have difficulties maintaining a correct foot position, or regaining their foot position and balance when the ball of their foot comes off a stirrup.

Furthermore, the stirrup 100 can be used as a teaching aid, as the positioner defined by the support bars 110 prevents the rider's feet from going forward in the stirrup 100, and thus helps maintain a correct and balance riding position.

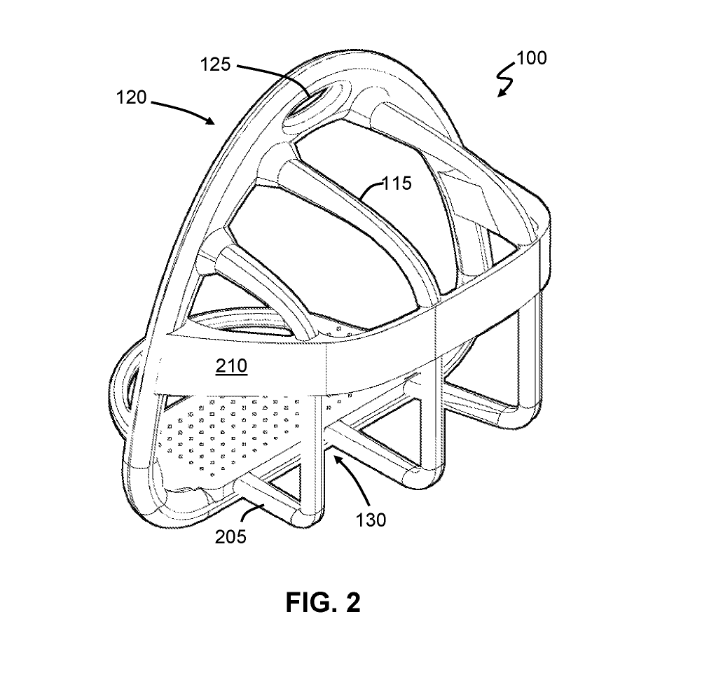

As best illustrated with reference to FIG. 2, the support bars 115 extend outwardly from the structural ring 105 in substantially the same plane as the tread 110, before bending upwards. As such, lower portions 205 of the support bars 115 can provide further support to the foot of the rider.

The stirrup further includes a brace 210, extending substantially horizontally across the support bars 115 from one side of the structural ring 105 to the other. The brace 210 prevents the support bars 115 from deforming under pressure, or separating, and thus can assist in preventing the rider's foot from getting caught between the support bars 115.

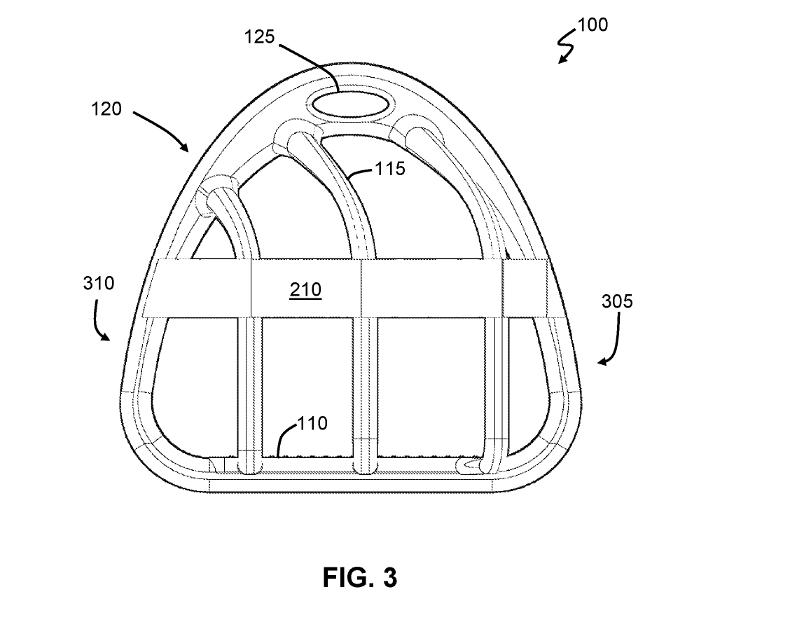

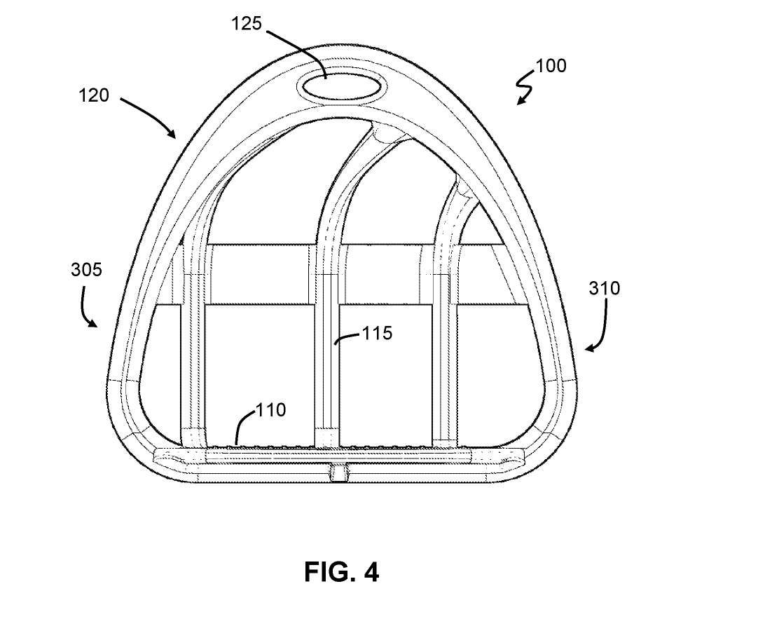

As best illustrated with reference to FIG. 3 and FIG. 4, a cage defined by the support bars 115 extend asymmetrically from one side of the structural ring 105 to another side of the structural ring 105. The cage (i.e. support) is thus adapted to support the rider's foot at an angle, and as such causes the rider's foot to ‘wedge’ into the stirrup 100 at an angle, and thus help prevent the rider's foot from accidently coming out of the stirrup 100 or slipping.

The asymmetric cage further assists in having the users foot (which is generally also asymmetric) from being correctly positioned in the stirrup 100. In particular, more space is given on an inside 305 of the stirrup 100 (i.e. where a large toe of the rider's left foot would be placed), and less space is given on an outside 310 of the stirrup 100, where a small toe of the rider's left foot would be seated.

To achieve and maintain balance when riding, the rider's centre of gravity must be directly over that of the horse. The horse's centre of gravity is in direct line with the girth of the saddle when the horse is standing still. As such, when the rider's feet are incorrectly placed on a stirrup, the rider becomes unbalanced. The stirrup 100, and in particular the support bars 115, help riders support their feet in the correct safety and balanced riding position.

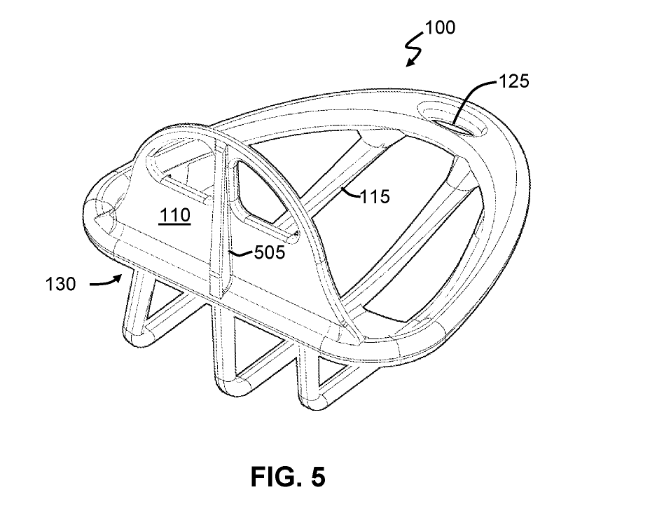

As best illustrated with reference to FIG. 5, the stirrup 100 includes a support brace 505 extending along a lower surface of the tread 110 to the structural ring 105. The support brace 505 further prevents the tread 110 from deforming or breaking under load and provides a smooth surface to prevent the stirrup causing any shoulder rubbing to the horse.

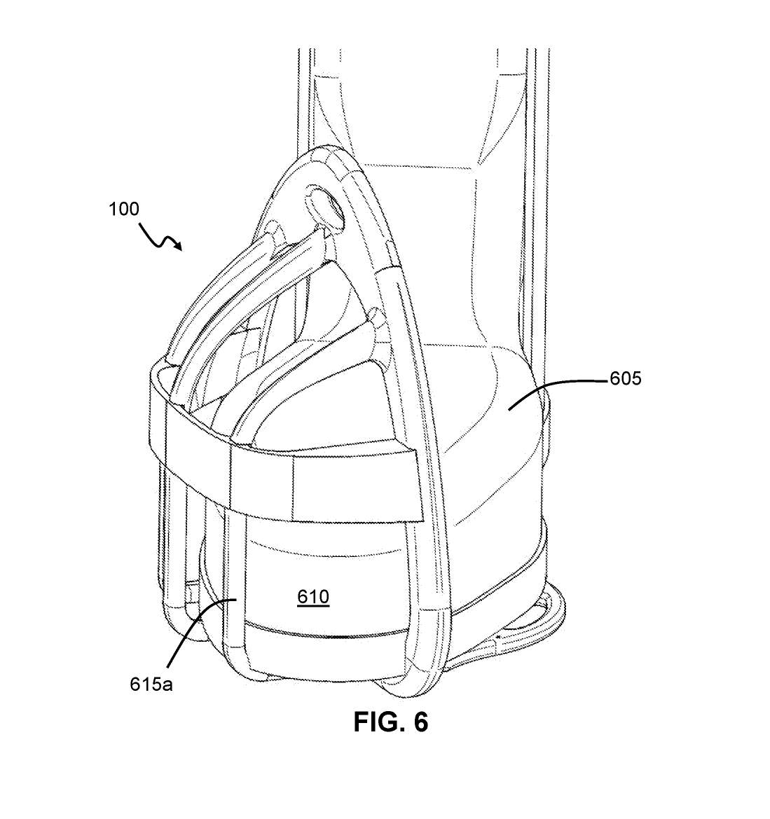

FIG. 6 illustrates the stirrup 100 with reference to a left riding boot 605, according to an embodiment of the present invention.

The riding boot 605 enters the stirrup at an angle of approximately 70 degrees relative to the structural ring 105, and a front 610 of the boot 605 is wedged between the structural ring 105 and a first support bar 615a of the support bars 115. An inside of the boot 605 is thus supported by the support bars, and the support bars 115 and the brace 205 face the horse. As such, the support bars 115 and, to some extent, the structural ring 105 define a positioner, for positioning the boot at an angle on the tread 110.

The position of the first support bar 115a, e.g. the distance between the first support bar 115a and the structural ring 105, defines an angle in which the boot 605 is supported. The skilled addressee will readily appreciate that careful selection of the position of the first support bar 115a can be used to define the angle at which the boot 605 is positioned.

The stirrup 100 of FIGS. 1-6 is a stirrup for a left foot. As will be readily appreciated by the skilled addressee, a stirrup for the right foot can be a mirrored copy of the stirrup 100 and is thus not described separately.

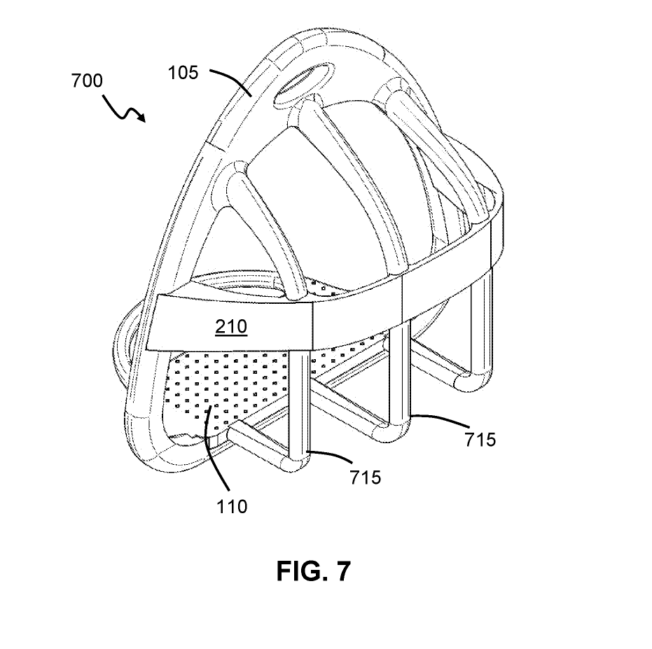

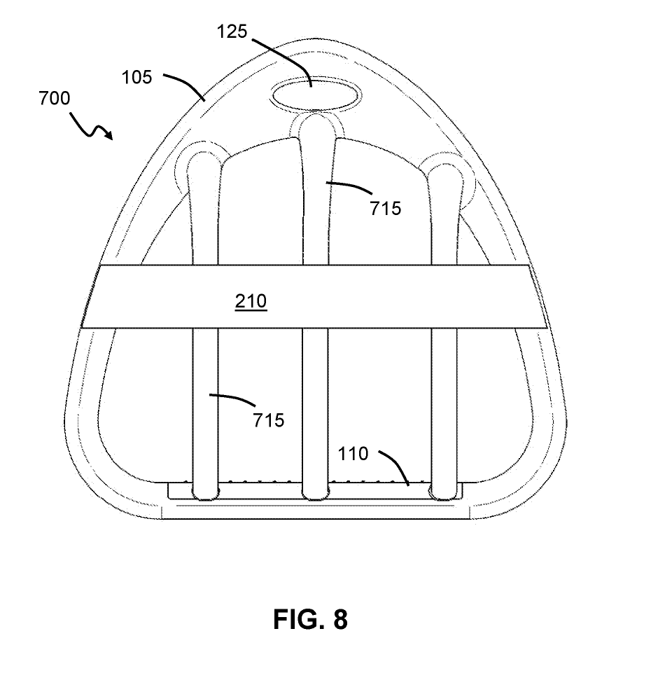

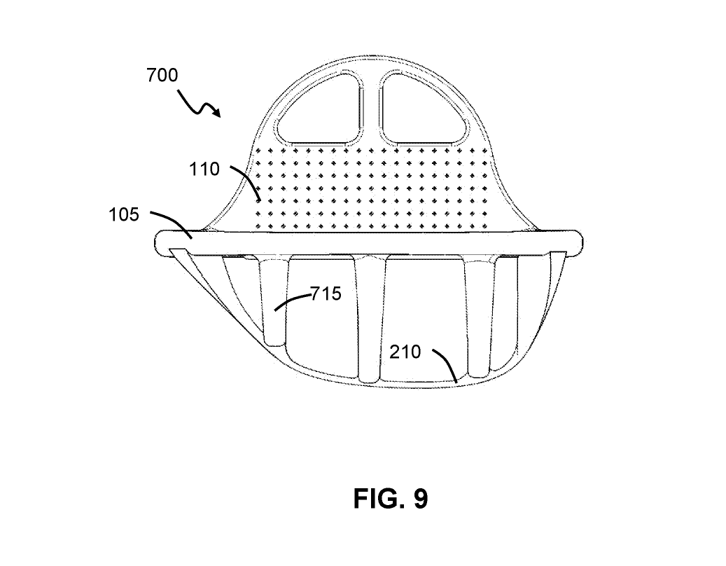

FIG. 7 illustrates a front upper perspective view of a stirrup 700, according to an embodiment of the present invention. FIG. 8 illustrates a front view of the stirrup 700 and FIG. 9 illustrates a top view of the stirrup 700.

The stirrup 700 includes a plurality of support bars 715, similar to the support bars 115 of FIG. 1, defining a positioner for positioning the boot 605 of the rider. As described in further detail below, the positioner can be used to position the boot 605 of the rider at an angle relative to the stirrup 700.

Similar to the support bars 115, the support bars 715 extend outwardly from a lower portion of the structural ring 105 in substantially the same plane as the tread 110, before bending upwards and inwards again, and joining an upper portion of the structural ring 105. However, as best illustrated with reference to FIG. 8 and FIG. 9, each of the support bars 715 extend outwardly, upwardly and then inwardly in a single plane that is substantially orthogonal to the structural ring 105.

A cage is defined by the support bars 715 that extends asymmetrically from one side of the structural ring 105 to another side of the structural ring 105, and is thus adapted to receive the rider's boot 605 at an angle. As discussed above, this causes the rider's boot 605 to ‘wedge’ into the stirrup 700 at an angle, and thus help prevent the rider's foot from accidently coming out of the stirrup 700 or slipping forward or sideways.

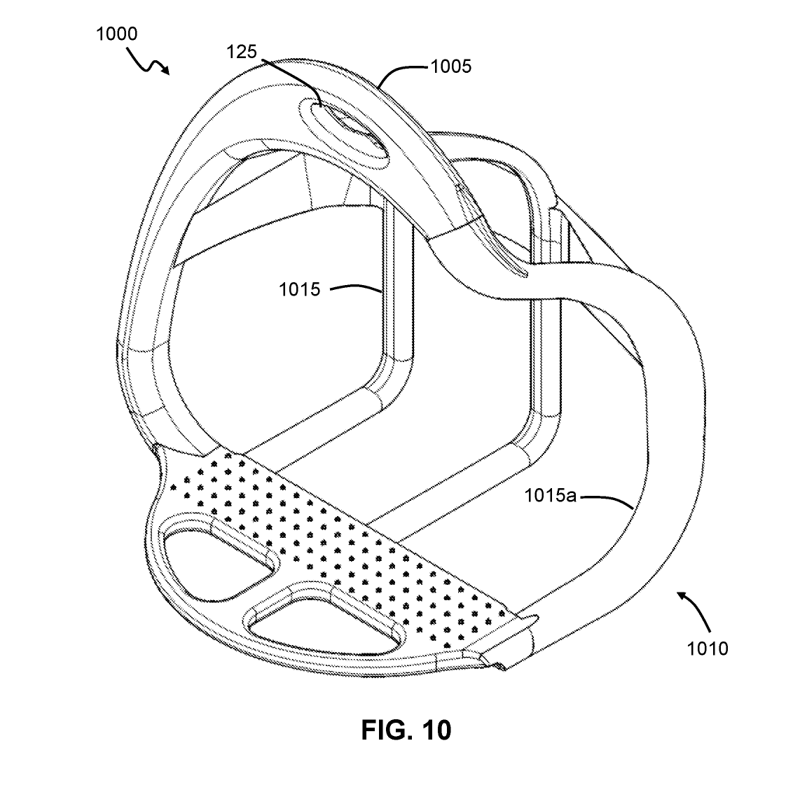

FIG. 10 illustrates a rear upper perspective view of a stirrup 1000, according to an embodiment of the present invention.

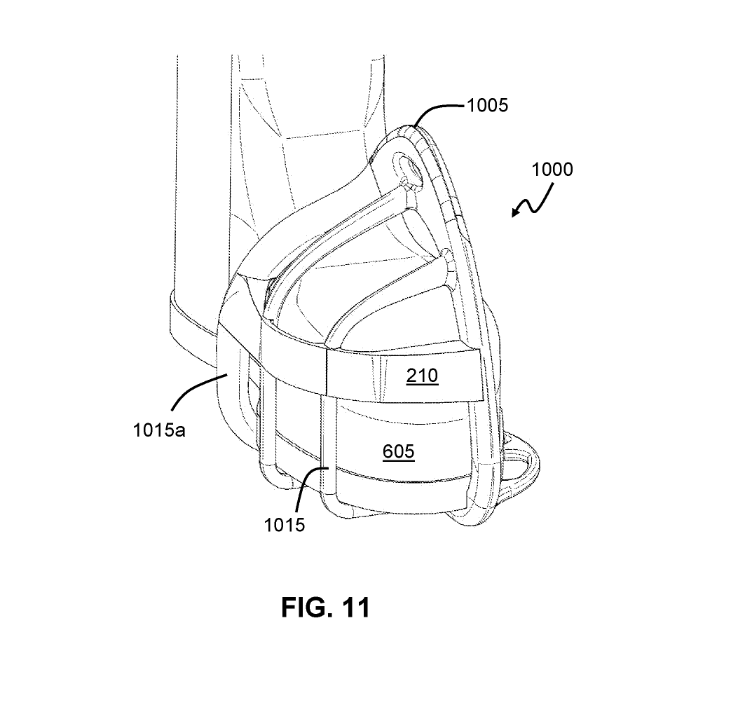

The stirrup 1000 includes a structural frame 1005, similar to the structural ring 105. The structural frame 1005 is, however, open on an outside 1010 of the stirrup 1000, enabling the rider's boot 605 to enter the stirrup nearly parallel to the frame 1005 of the stirrup 1000, as illustrated with reference to FIG. 11.

The stirrup 1000 further includes support bars 1015, similar to the support bars 115, which define a cage that extends asymmetrically from one side of the structural frame 1005 to another side of the structural frame 1005. The support bars 1015 include an inner support bar 1015a, that is thicker than the other support bars 1015. The inner support bar 1015a provides structural support to the stirrup 1000 in the absence of any structural frame 1005 on the inside of the stirrup.

As discussed above and illustrated with reference to FIG. 11, the support bars 1015 causes the rider's boot 605 to ‘wedge’ into the stirrup 1000 at an angle, in this case nearly at 90 degrees to the stirrup 1000. The stirrup 1000 can thus help prevent the rider's foot 605 from accidently coming out of the stirrup 1000 or slipping forward or sideways.

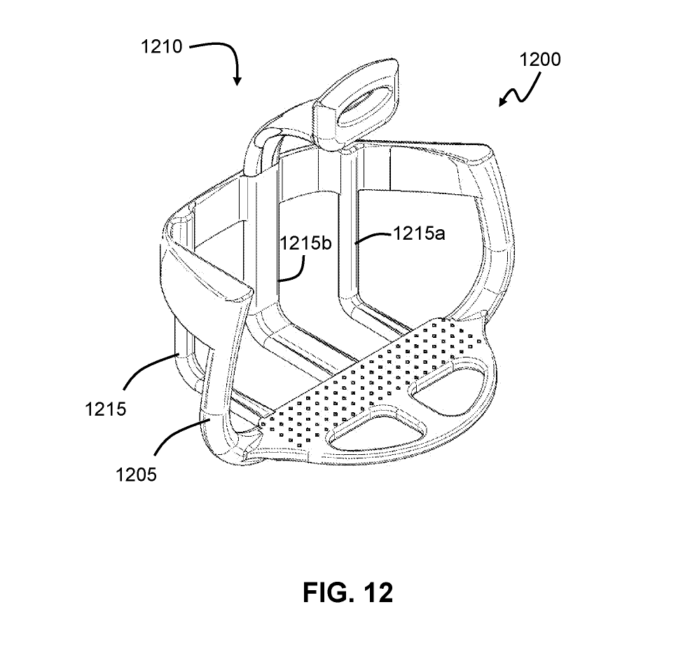

FIG. 12 illustrates a rear upper perspective view of a stirrup 1200, according to an embodiment of the present invention.

The stirrup 1200 includes a structural frame 1205, similar to the structural ring 105. The structural frame 1205 is, however, open on an upper side 1210 of the stirrup 1200, which can further prevent the rider's foot from catching in the structural frame 1205 in case of a fall.

The stirrup 1200 further includes support bars 1215, similar to the support bars 115, which define a cage that extends from one side of the structural frame 1205 to another side of the structural frame 1205.

The support bars 1215 include outer support bars 1215a, which provide support to the riders foot (i.e. the left foot), and a central support bar 1215b, which is thicker than the outer support bars 1215a, and is used to support the stirrup 1200.

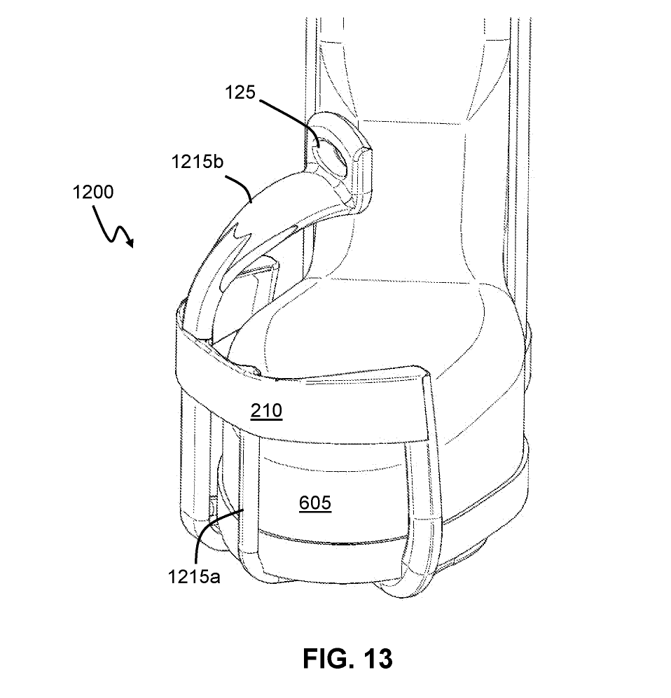

While the cage defined by the support bars 1215 is substantially symmetrical, it enables the rider's boot 605 to enter the stirrup at an angle to the stirrup 1200, as illustrated with reference to FIG. 13.

The central support bar 1215b is thicker than the outer support bars 1215a and extends above the outer support bars 1215a. The central support bar 1215b provides structural support to the stirrup 1200 in the absence of any structural frame 1005 on the upper side 1210 of the stirrup 1200.

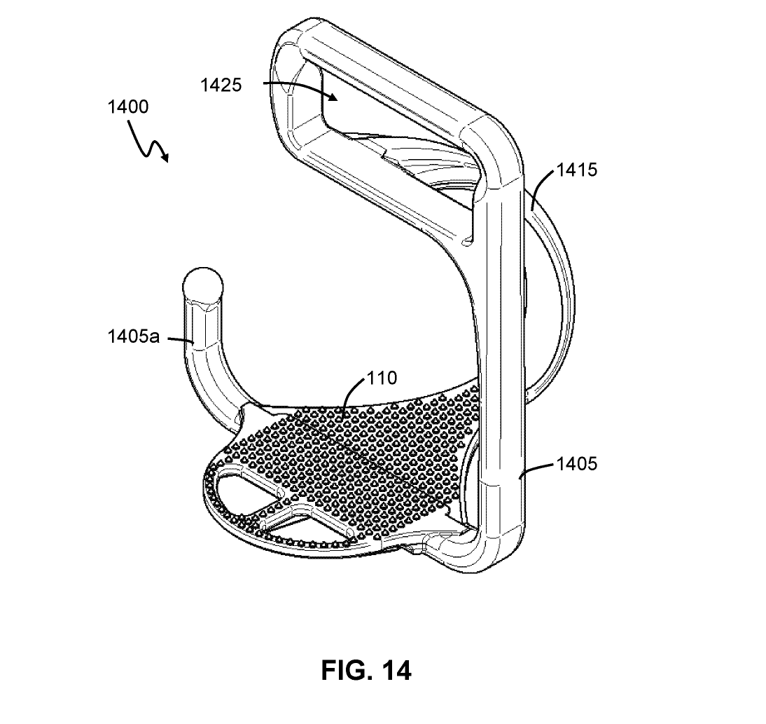

FIG. 14 illustrates a rear upper perspective view of a stirrup 1400, according to an embodiment of the present invention. The stirrup 1400 includes a structural frame 1405 and a support bar 1415, similar to the structural frame 1005 and support bars 1015 respectively of FIG. 10.

The structural frame 1405 defines an outer bar 1405a, which extends outwardly and upwardly from the tread 110. The front of the rider's boot is wedged between the support bar 1415 and the outer bar 1405a, which prevents the boot from slipping forward and keeps the boot in the correct position. As such, the support bar 1415 and the outer bar 1405a define a positioner, for positioning the rider's boot at an angle on the tread 110. This in turn ensures that the ball of the rider's foot is supported by the tread 110, and helps keep the rider's heels down.

The structural frame 1405 defines an opening above the outer bar 1405a, which allows room for the foot to come out easy in the event of a fall. The support bar 1415 further provides structural support to the stirrup 1400 in the absence of any structural frame 1405 at the opening. An upper portion of the outer bar 1405a is rounded, to prevent injury to the rider on impact.

Finally, the structural frame 1405 defines an aperture 1425, similar to the aperture 125 of FIG. 1, but much larger and elongate. Furthermore, the aperture 1425 is substantially rectangular shaped. In use, the stirrup is hung by a strap that extends through the aperture 1425.

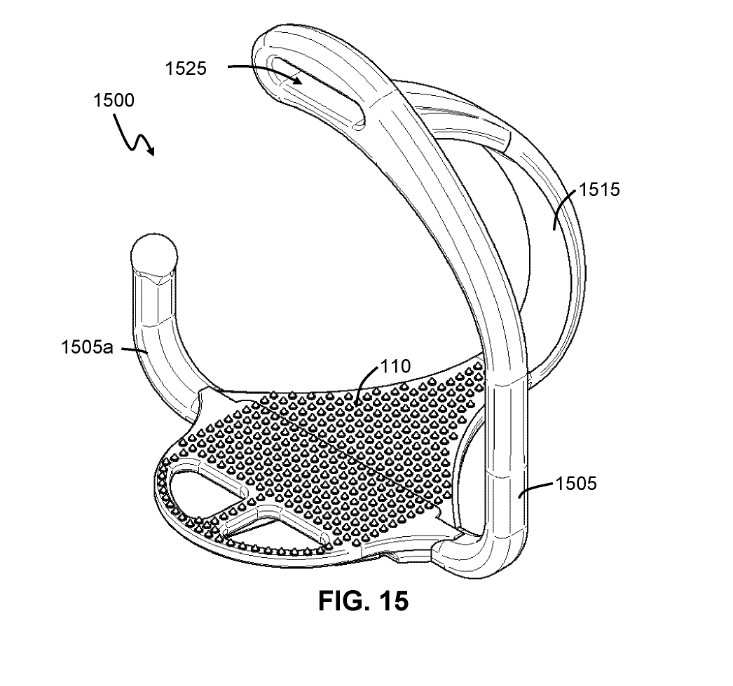

FIG. 15 illustrates a rear upper perspective view of a stirrup 1500, according to an embodiment of the present invention. The stirrup 1500 includes a structural frame 1505 and a support bar 1515 and is similar to the stirrup 1400 of FIG. 14.

The structural frame 1505 defines an outer bar 1505a, similar to the outer bar 1405a, which extends outwardly and upwardly from the tread 110. The front of the rider's boot is wedged between the support bar 1515 and the outer bar 1505a, which prevents the boot from slipping forward and keeps the boot in the correct position, in a similar manner to that described above with reference to the stirrup 1400.

The structural frame 1505 defines an opening above the outer bar 1505a, which allows room for the foot to come out easy in the event of a fall. The support bar 1515 further provides structural support to the stirrup 1500 in the absence of any structural frame 1505, as described above with reference to the stirrup 1400.

Finally, the structural frame 1505 defines an aperture 1525, similar to the aperture 125 of FIG. 1 and the aperture 1425 of FIG. 14. The aperture 1525 is elongate, and has substantially parallel upper and lower walls. In use, the stirrup is hung by a strap that extends through the aperture 1525.

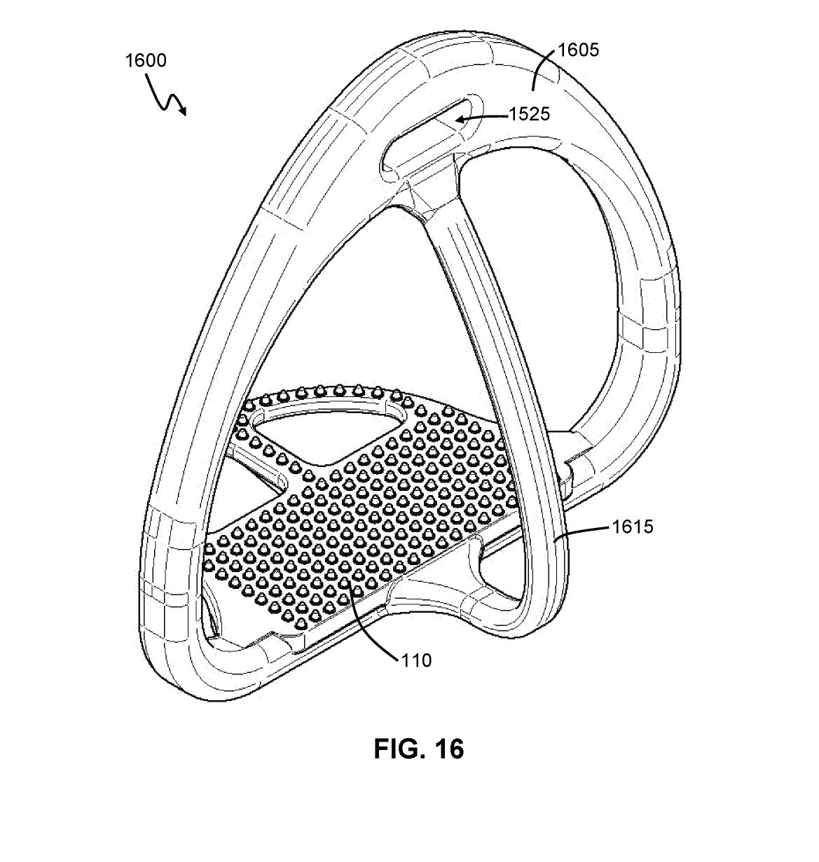

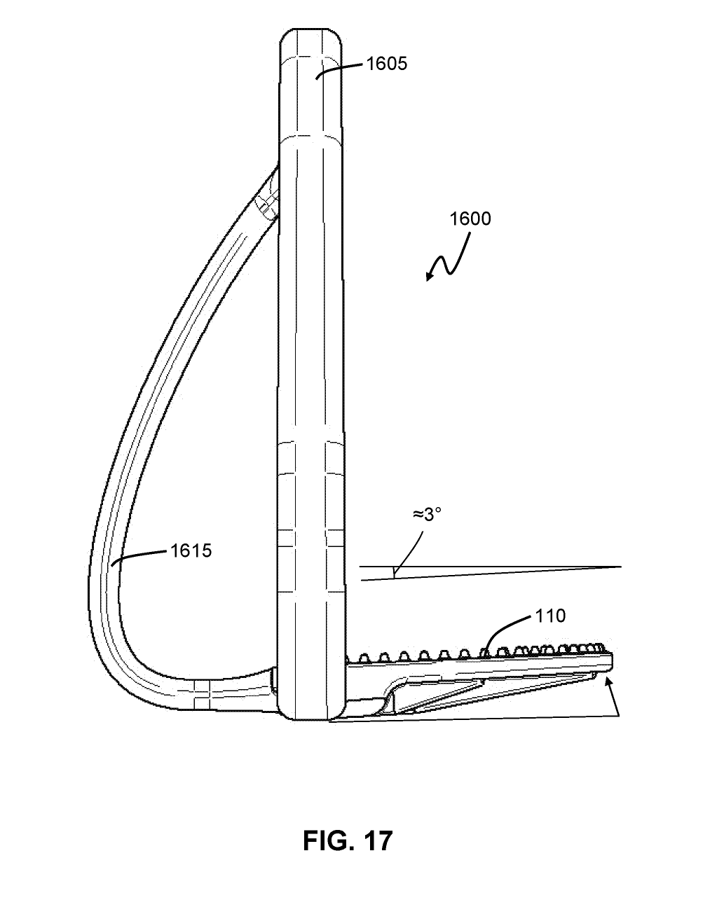

FIG. 16 illustrates a front upper perspective view of a stirrup 1600, according to an embodiment of the present invention. FIG. 17 illustrates a side view of the stirrup 1600.

The stirrup 1600 includes a structural ring 1605 and a support bar 1615, which together define a positioner for positioning the boot of the rider. In particular, the structural ring 1605 and a support bar 1615 are used to position the boot of the rider at an angle relative to the stirrup and against the horse, creating more support and balance for the rider and helping keep the rider's heels down.

As best illustrated with reference to FIG. 17, the tread 110 is angled downwards towards the ring, and by approximately 3° relative to a normal of the ring 1605. Similarly, the elevated platform, which is defined by a lower portion of the support bar 1615, continues downwards away from the ring 1605. These features further assist in providing support and balance to the rider.

Finally, the support bar 1615 extends outwardly from a lower portion of the structural ring 1605 in substantially the same plane as the tread 110, before bending upwards and inwards again, and joining an upper portion of the structural ring 1605.

The stirrup 100, 700, 1000, 1200, 1400, 1500, 1600 can be integrally formed, for example by plastic polymer, stainless steel, aluminium or another metal.

The support bars 115, 715, 1015, 1215, 1415, 1515, 1615 at least partly define a cage or stopper preventing the foot of the rider from extending through the structural ring or frame 105, 1005, 1205, 1405, 1505, 1605, and provide an ergonomic, safe and balanced riding position. The skilled addressee will, however, readily appreciate that the cage or stopper can be defined in a various other ways. For example, the support bars 115, 715, 1015, 1215, 1415, 1515, 1615 can be vertical, horizontal, formed of a lattice structure, or alternatively comprise a partly or fully enclosed surface, and the cage or stopper can be defined partly by the structural ring or frame 105, 1005, 1205, 1405, 1505.

According to certain embodiments, the cage defined by the support bars 115, 715, 1015, 1215, 1415, 1515, 1615 extends further forward from the structural ring 105 or structural frame 1005, 1205, creating a longer pocket and therefore, additional foot support. This is particular advantageous for apprentices, when riding problem horses, or for jumps jockeys.

While the present specification uses the terms feet, and in particular toes and the ball of the foot, the skilled addressee will readily appreciate that a rider will generally be wearing footwear, such as riding boots. In such case, the positioner, for example, may position the rider's foot indirectly by positioning the rider's footwear.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A horse stirrup including:
a support, for supporting an underside of footwear of a rider; and
a positioner, for positioning the footwear of the rider relative to the support.

2. The stirrup of claim 1, wherein the positioner is adapted to position the foot of the rider obliquely relative to the support.

3. The stirrup of claim 1, wherein he positioner is asymmetric along a lateral axis of the stirrup.

4. The stirrup of claim 1, wherein the positioner comprises a cage, adapted to receive a front portion of the rider's foot.

5. The stirrup of claim 4, wherein the cage extends asymmetrically from one side of the stirrup to another side of the stirrup.

6. The stirrup of claim 1, further comprising a structural frame supporting the support.

7. The stirrup of claim 6, wherein the structural frame comprises a structural ring.

8. The stirrup of claim 6, wherein the structural frame includes an opening, which allows the foot to come out of the frame in the event of a fall.

9. The stirrup of claim 8, wherein the structural frame defines an outer bar which extends outwardly and upwardly from the support, and wherein the opening is defined above the outer bar.

10. The stirrup of claim 6, wherein the support is defined in part by the structural frame.

11. The stirrup of claim 6, wherein the support extends outwardly from a lower portion of the structural frame, in a direction that is substantially orthogonal to the structural frame.

12. The stirrup of claim 1, wherein the support is a tread.

13. The stirrup of claim 1, wherein the positioner comprises one or more support bars.

14. The stirrup of claim 13, wherein the support bars extend outwardly from a lower portion of a structural frame and then upwards.

15. The stirrup of claim 14, wherein the support bars finally extend inward again, to join with an upper portion of the structural frame.

16. The stirrup of claim 13, further including a brace, extending across the support bars.

17. The stirrup of claim 1, further comprising an aperture for hanging the stirrup.

18. The stirrup of claim 1, wherein the support includes a plurality of raised protuberances defining a gripping surface on the support.

19. The stirrup of claim 1, wherein the stirrup is integrally formed.

20. The stirrup of claim 1, wherein the stirrup is integrally formed of plastic polymer, stainless steel, or aluminium.
